(19) United States
(12) Patent Application Publication
(10) Pub. No.: US 2008/0038955 A1
(43) Pub. Date: Feb. 14, 2008

(54) CLIP FOR SECURING A CORD PLUG TO A CORD SOCKET

(76) Inventor: Justin Miles Discoe, Fort Collins, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/464,011

(22) Filed: Aug. 11, 2006

(51) Int. Cl. H01R 13/62

(52) U.S. Cl. 439/369

(57) ABSTRACT

A clip for securing a cord plug to a cord socket. One version of the clip has a set of opposed channels arranged to receive flanges extending from the plug and socket. The clip has a second set of opposed channels aligned with but narrower than the first set of channels, to receive tabs extending from either the plug or socket. These channels engage the flanges and tabs to secure the plug and socket together and prevent unwanted separation, when a separation force is provided. The clip also has openings in the sides of the clip to allow the plug and socket bodies or the cord to pass through the sidewalls, allowing the clip to surround the connected plug and socket.

### FIELD OF THE INVENTION

Aspects of the present invention involve an apparatus for securing a cord plug to a cord socket.

### BACKGROUND

Some strings of holiday lights provide a socket at the end of the string to allow the user to connect multiple strings together in a series. This prevents the user from having to plug each string into an electrical socket individually. Similarly, extension cords can also be connected in series to provide for a longer extension cord. However, the plug and socket connections between the light strings oftentimes separate during use. Separation can be very inconvenient. For example, a string of holiday lights hung from the eaves of a house or in a tree often requires the user to fetch a ladder to reconnect the plug and socket in the event that they are accidentally separated. Furthermore, continued separation of extension cords would require unnecessary delays to a project to reconnect the plug and socket. Because of at least the inconvenience associated with the separation of a plug and socket from serial connected light strings or extension cords, what is needed is a way to secure the connection to prevent unwanted separation until the user is ready to manually separate the plug and socket.

### SUMMARY

One aspect of the present invention involves a clip for securing a cord plug and cord socket. The clip includes a support surface including a first region and a second region. A first member extends away from the first region of the support surface, the first member defining a first channel. A second member extends away from the second region, the second member defining a second channel. In one particular implementation, the first member also defines a third channel and the second member also defines a fourth channel. The first channel and the second channel receive tabs extending from the cord socket while the third channel and the fourth channel receive circumferential flanges extending from both the cord socket and the cord plug. These channels engage the flanges and tabs to secure the plug and socket together and prevent unwanted separation, when a separation force is provided.

Another aspect of the present invention also involves a clip for securing a cord plug and a cord socket. The clip includes a support surface including a first region and a second region. A first upstanding portion extends from the first region of the support surface. The first upstanding portion defines a first channel with a first width and a third channel with a third width. The third width is generally greater than the first width. A second upstanding portion extends from the second region of the support surface. The second upstanding portion defines a second channel with a second width and a fourth channel with a fourth width. The fourth width is generally greater than the second width. The support surface, the first upstanding portion and the second upstanding portion define a first opening for receiving a plug body and a second opening for receiving a socket body.

Another aspect of the present invention involves a method for securing a cord plug to a cord socket. The method includes connecting the cord plug to the cord socket, placing the connected plug and socket within a receptacle of a clip, and snapping a cover over the receptacle to hold the plug and socket within the clip. When placed in the clip, the cord extending from the plug and the cord extending from the socket pass through openings in the sidewalls of the clip. In one particular implementation, the openings in the sidewalls cradle the plug and socket bodies.

### BRIEF DESCRIPTION OF THE DRAWINGS

FIG. 1 is an isometric view of a clip according to one embodiment of the invention.

FIG. 2 is a bottom view of the clip according to one embodiment of the invention.

FIG. 3 is a top view of the clip with the flap open to illustrate the clip securing a cord plug and cord socket according to one embodiment of the invention.

FIG. 4 is an isometric view of a second clip according to one embodiment of the invention.

### DETAILED DESCRIPTION

Aspects of the present invention involve a clip for securing a cord plug and cord socket. The clip is employed to surround the cord plug and socket, holding the plug and socket together to prevent unwanted separation. A snapping device may further be employed to hold the clip in place around the plug and socket. The snap also helps prevent the clip from being easily or accidentally removed. The clip can be adapted to fit many different styles and sizes of cord plugs and sockets. In one particular arrangement, the clip is conformed to secure the plug and socket of two holiday light strings plugged together.

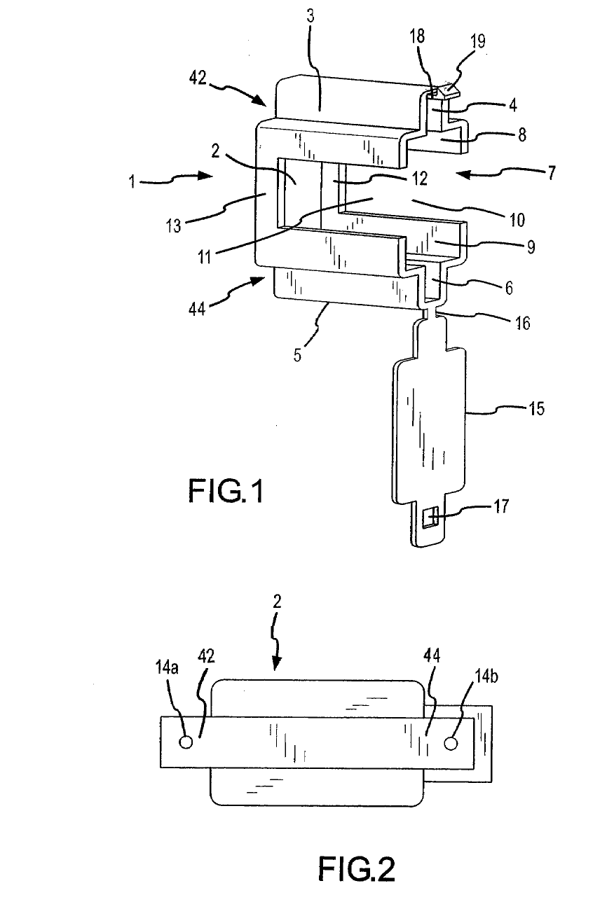

FIG. 1 illustrates one particular embodiment of a clip. Referring to FIGS. 1 and 2, the clip 1 includes a base 2 supporting a first upright member 3 and a second upright member 5. The base 2 has a generally rectangular shape with a rectangular main section, and a pair of opposed narrower sections at either end of the main section. The narrower sections are generally of the same dimension as the width of a first and a second channel (4,6) of the upright members, discussed in greater detail below. The main section is of generally the same dimension as the width of a third and a fourth channel (8,9) of the upright members, also discussed in greater detail below. As illustrated in FIG. 2, a particular implementation of a clip 1 may include at least one drainage hole 14 in the base 2. In the particular implementation set forth herein, drainage holes (14a,14b) are defined in each of the narrower sections of the base 2. The drainage holes allow for air to flow through the clip as well as moisture to drain from the clip, helping to prevent corrosion of the cord plug and socket.

Referring to FIG. 1, the first upright member 3 and the second upright member 5 define longitudinal openings running the length of the upright members. These openings form two pair of cooperating channels that operate to secure a cord plug and socket. Discussed in greater detail below, the outer channels receive tabs extending from the body of the cord socket while the inner channels receive circumferential flanges extending from the body of the socket and the plug. The channels receive the referenced plug and socket features to prevent unwanted separation of a connected plug and socket.

In one particular implementation, the first upright member 3 extends generally perpendicularly from the base 2. The first upright member 3 has a generally Y-shape comprising a first u-shaped portion with a first width and a second u-shaped portion with a second width wider than the first. The first width defines the first channel 4 and the second width defines the third channel 8. The width of the third channel 8 is generally greater than the width of the first channel 4. Similarly, the second upright member 5 extends generally perpendicularly from the base 2. The second upright member 5 also has a generally Y-shape comprising a third u-shaped portion with the first width (same width as the first u-shaped portion) and a fourth u-shaped portion with the second width (same width as the second u-shaped portion), a mirror image of the first upright member 3. The third width defines a second channel 6 and the fourth width defines a fourth channel 9. The width of the fourth channel 9 is generally greater than the width of the second channel 6.

The channels of the first upright member 3 and second upright member 5 are oriented with the channel openings towards each other, such that the base 2, the first upright member 3, and the second upright member 5, form a receptacle 7 defining corresponding outer channels (4,6) and inner channels (8,9). The first channel 4 and the second channel 6 define the outer channels (4,6) of the receptacle 7. The third channel 8 and the fourth channel 9 define the inner channels (8,9) of the receptacle 7. The outer and inner channels of the receptacle 7 of a clip conforming to aspects of the present invention can be altered to correspond to the many shapes and sizes of different cord plugs and sockets.

Sidewalls (12, 13) extend perpendicularly from the base 2, between the first upright member 3 and the second upright member 5, forming the sides of the receptacle 7. The first upright member 3 and the second upright member 5 generally extend further from the base than the sidewalls (12,13), collectively creating generally u-shaped openings in the sides of the receptacle 7. The first u-shaped opening 10 is formed to cradle the body of the cord socket. The second u-shaped opening 11 is formed to cradle the body of the cord plug. In general, the u-shaped openings (10,11) can be altered to cradle many different sizes of cord plugs and sockets.

As illustrated in FIG. 1, a particular implementation of a clip may include a device to hold the clip in place around the cord plug and socket. In the particular implementation set forth herein, a flap 15 is attached to the outside edge of the second upright member 5 by an integrated hinge 16. The hinge 16 may include any manner to hingedly connect the flap 15 to the second upright member 5. In the particular implementation, the entirety of the clip 1 is an injection molded piece; thus the hinge 16 is integrated with the clip 1. It is also possible to construct the clip from some combination of discrete components.

The flap 15 has generally the same shape as the base 2. The flap 15 has a generally rectangular shape with a rectangular main portion, and a pair of opposed narrower portions at either end of the main portion. The clip 1 includes a snap or other similar structure to secure the flap 15 to the receptacle 7. In the particular implementation set forth herein, the narrow portion at the opposite end of the hinge 16 contains a slot 17 in the flap 15. A tab 18 is attached to the outside edge of the first upright member 3. The tab 18 includes a flange 19 extending perpendicularly away from the clip 1. The top of the flange is sloped to allow the slot to engage the tab. In the closed position, the tab 18 snaps into the slot 17 such that the flange 19 engages the edge of the slot 17 to hold the flap 15 in place. The flap 15 can be released from the tab 18 by sliding the tab through the slot 17 and releasing the flap 15. Any manner of a snap device holding the flap in place may be implemented.

Other embodiments may be implemented to hold the clip 1 in place around the cord plug and socket. By way of example, and not limitation, a releasable cover rather than the flap may be implemented to hold the plug and socket in the clip. In this particular implementation, the releasable cover has generally the same shape as the flap 15. The cover snaps onto the first and second upright members through any manner of snap devices, thereby covering the receptacle 7. For example, the cover can have two slots, one positioned as with slot 17 described above, and the other positioned in the other opposing narrower section of the flap. The clip includes the same tab structure 19, and an additional second identical tab structure on the opposite upright member. The cover slots then may snap onto the two tabs.

A second example of a flap would include a tab located on the flap that would engage a slot or snapping device located on the first upright member when the flap is in the closed position, essentially reversing the position of the tab and slot. These embodiments are examples of some possible devices implemented to hold the clip in place around the cord plug and socket.

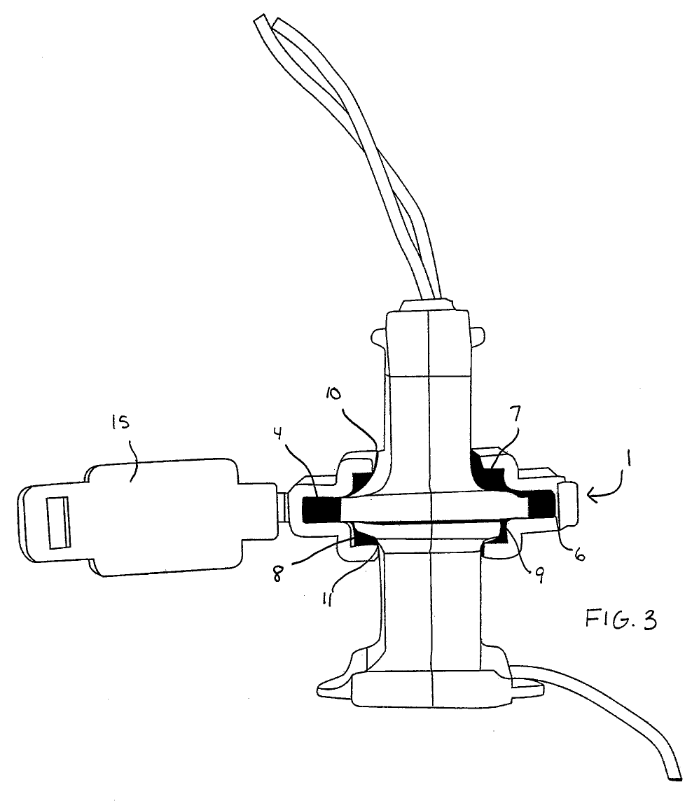

FIG. 3 illustrates the clip 1 employed to secure a cord plug and socket from separating. Both the plug and socket have a circumferential flange at the outer edge. Additionally, tabs extend from either side of the socket body. When not within the clip, a person may grab the tabs to pull apart the cord and socket. Referring to FIG. 3, the connected cord plug and socket are held together by the clip 1. The cord plug and socket are cradled by the receptacle 7 and the unshaped openings (10,11). The first and second channels (4,6) (outer channels) of the receptacle 7 receive the tabs of the socket. The third and fourth channels (8,9) (inner channels) receive the circumferential flanges of the plug and socket. Supported in this manner, the clip 1 acts to prevent the separation of the cord plug from the cord socket. The base 2 and flap 15 are used to hold the clip 1 in place around the cord plug and socket to help prevent the clip from being accidentally removed or simply falling off.

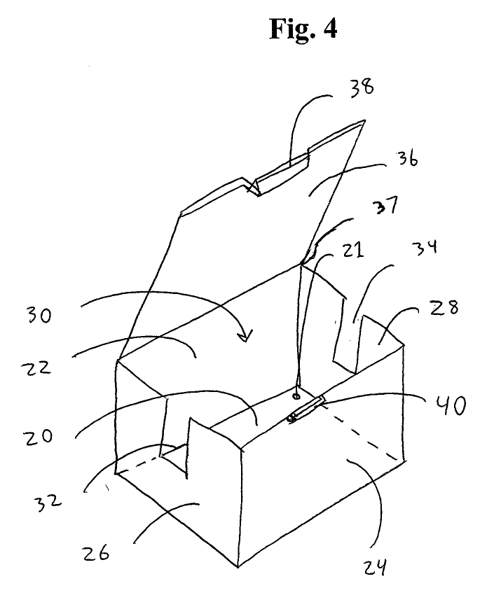

FIG. 4 illustrates one possible embodiment of the clip allowing for the cord plug and socket to be fully contained within the receptacle. In this particular implementation of a clip, a base 20 has a generally rectangular shape. A particular implementation of the clip may include at least one drainage hole 21 in the base 20. Extending upward from the base are four walls (22, 24, 26, 28) forming a generally box-like structure. The base 20 and the four walls (22, 24, 26, 28) form a receptacle 30, with cooperating first and second channels. A first generally u-shaped opening 32 is defined by one of the walls. A second generally u-shaped opening 34 is defined by the wall opposite the first opening 32. The first and second opening allow for the cord extending from the cord plug and socket to pass through the wall. The inner edge of the wall (26,28) adjacent the openings (32,34) engage the socket body and plug body preventing separation of the same. Other embodiments may be implemented to provide for the second opening to be located on an adjacent wall to the first opening to allow use of different styles of cord plugs and sockets.

Referring to FIG. 4, the particular implementation of the clip may include a device to hold the clip in place around the cord plug and socket. In FIG. 4, a flap 36 is attached to one of the walls 24 by an integrated hinge 37. The hinge 37 may include any manner to hingedly connect the flap 36 to the wall 24. In the particular implementation, the entirety of the clip is an injection molded, thus the hinge 37 is integrated with the clip. The flap 36 has generally the same shape as the base. The clip includes a snap or other similar structure to secure the flap 36 to the receptacle 30. In FIG. 4, a tab 38 similar to the tab 18 of FIG. 1 is attached to the flap 36. A slot 40 is located on the wall opposite the hinge 37, near the opening to the receptacle 30. In the closed position, the tab 38 snaps into the slot 40 in a similar manner as described above. Any manner of a snap device holding the flap in place may be implemented.

Although various representative embodiments of this invention have been described above with a certain degree of particularity, those skilled in the art could make numerous alterations to the disclosed embodiments without departing from the spirit or scope of the inventive subject matter set forth in the specification and claims. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected to another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

1-12. (canceled)

13. A clip for securing a cord plug and a cord socket, comprising;
a support surface including a first region and a second region;
a first upstanding portion extending from the first region of the support surface, the first upstanding portion defining a first channel with a first width, the first upstanding portion further defining a third channel with a third width greater than the first width;
a second upstanding portion extending from the second region of the support surface, the second upstanding portion defining a second channel with a second width, the second upstanding portion further defining a fourth channel with a fourth width greater than the second width; and
the support surface, the first upstanding portion and the second upstanding portion defining a first opening for receiving a plug body and a second opening for receiving a socket body such that a portion of the plug body and a portion of the socket body are retained within the clip, and a second portion of the plug body and any wiring extending from the plug body and a second portion of the socket body and any wiring extending from the socket body are outside the clip.

14. The clip of claim 13 wherein:
the first width is substantially the same as the second width; and
the third width is substantially the same as the fourth width.

15. The clip of claim 13 wherein the support surface includes at least one drainage hole.

16. The clip of claim 13 further comprising a cover releasably coupled with at least the first upstanding portion.

17. The clip of claim 16 wherein the cover is releasably coupled to the first upstanding portion with a snap device.

18. The clip of claim 17 wherein the cover defines a flap hingedly attached to the second upstanding portion, wherein the flap includes a slot.

19. The clip of claim 18 further comprising;
a tab operatively connected to the first upstanding portion wherein the tab engages the slot to lock the flap in place.

20. (canceled)
